(19) United States
(12) Patent Application Publication
(10) Pub. No.: US 2011/0197493 A1
(43) Pub. Date: Aug. 18, 2011

(54) Multi-Functional Fishing Lure Assembly

(76) Inventors: Janifer W. Kwong, Fremont, CA (US); Leslie W. Kwong, Fremont, CA (US)

(21) Appl. No.: 12/706,598

(22) Filed: Feb. 16, 2010

(51) Int. Cl. A01K 85/01

(52) U.S. Cl. 43/42.06; 43/42.24

(57) ABSTRACT

A multi-functional fishing lure assembly to generate visual simulation and scent, the multi-functional fishing lure assembly consists essentially of a soft, flexible and elongated body portion which has two ends, one end detachably coupled with a fishing hook, the opposite end attached integrally to an elongated tail portion, a chamber that has an opening disposed in the elongated body portion and covered by a lid portion which has slits and apertures, a volume of active ingredients that contains scent material, color material, bubbles generating material and combination thereof, which can be reloaded and reused.

### RELATED APPLICATION(S)

None.

### FIELD OF THE INVENTION

This invention relates to a multi-functional fishing lure, and more particularly to a fishing lure assembly that uses visual stimulation and scent to effectively attract predatory fish.

### BACKGROUND OF THE INVENTION

A fishing lure is an object attached to the end of a fishing line which is designed to resemble and move like the prey of a fish. The purpose of the lure is to use movement, vibration, and color to catch the fish's attention so it bites the hook. Lures are equipped with one or more single, double, or treble hooks that are used to hook fish when they attack the lure.

A plastic worm is a common lure fisherman use to catch fish. It works because it mimics the movement of a real worm, one of their natural preys in the food chain. Fish locate its prey in two ways, by their keen sense of smell and sight. The visual stimulus can be light, movement of the lure, bubbles, etc.

It is widely believed by fishing enthusiasts that predatory fish is more prone to attack/swallow plastic lure if it carries a strong scent and produces an attractive movement that will trigger a predatory instinct to launch an instant strike. Therefore, some plastic lures come with different scents to enhance its effectiveness. There are commercially available products in the market that strive to achieve that goal; a spray-on mist (oil) that coats the lure with a thin layer of scent. However, these products have disadvantages and flaws. The scent will wear-off quickly and there is also no way of gauging the level of scent left on the lure because of its invisibility. For those reasons its potency is greatly reduced and becomes less effective. Moreover, a spray on mist is only effective if the lure it is applied to have an absorbing surface.

U.S. Pat. No. 6,061,947 issued May 16, 2000 to Mooers discloses a fishing lure having a scent plug. It however does not create any color cloud or bubbles. U.S. Pat. No. 7,562,489 issued Jul. 21, 2009 to Turner discloses a light emitting fishing lure that consists of a scent cavity. It is however electrically operated and needs inlet ports and outlet ports to disperse the scent. U.S. Pat. No. 7,228,656 issued Jun. 12, 2007 to Mitchell et al. discloses a fishing lure with chambers that generates scent. It however requires at least two chambers to hold ionic attractant scent compound and ion exchange material. It also does not generate any color cloud or bubbles.

### ADVANTAGES AND SUMMARY OF THE INVENTION

The present invention is a fishing lure that has a flexible body and the capability to generate visual stimulations and scent while in contact with aqueous environment such as fresh water and salt water. It combines all the advantages of commercially available spray on scent fishing lure with additional benefits.

One advantage and object of the present invention is to provide an easy to carry fishing lure that can be used with or without the attractant tablets. When in use without the tablet, the present invention is an effective fishing lure that mimic movement of a worm, an insect or a small fish to lure predatory prey. With the application of attractant tablets, additional visual stimulations and scent are dispersed and released over time to increase effectiveness of catching a predatory fish.

Another advantage and object of the present invention is to provide a visible, definitive way to tell when to attractant tablets need replacement.

Yet another advantage and object of the present invention is the combination of visual stimulations such as color and bubbles and scent to largely increase the chances of catching a fish.

Yet another advantage and object of the present invention is the simplicity in both structure and operation. No complicated mechanical construction and/or electrical installment is required to achieve high effectiveness compared to prior art.

Further details, objects and advantages of the present invention will become apparent through the following descriptions, and will be included and incorporated herein.

### BRIEF DESCRIPTION OF THE DRAWINGS

FIGS. 1A, 1B and 1C are representative side view of multi-functional fishing lure of the present invention 100 showing the employment of attractant tablet 104.

FIG. 1D is a representative expanded view showing details of chamber lid 122.

FIG. 2 is a representative side view of an alternative embodiment of multi-functional fishing lure of the present invention 100′.

FIG. 3 is a representative view of application of multi-functional fishing lure of the present invention 100.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

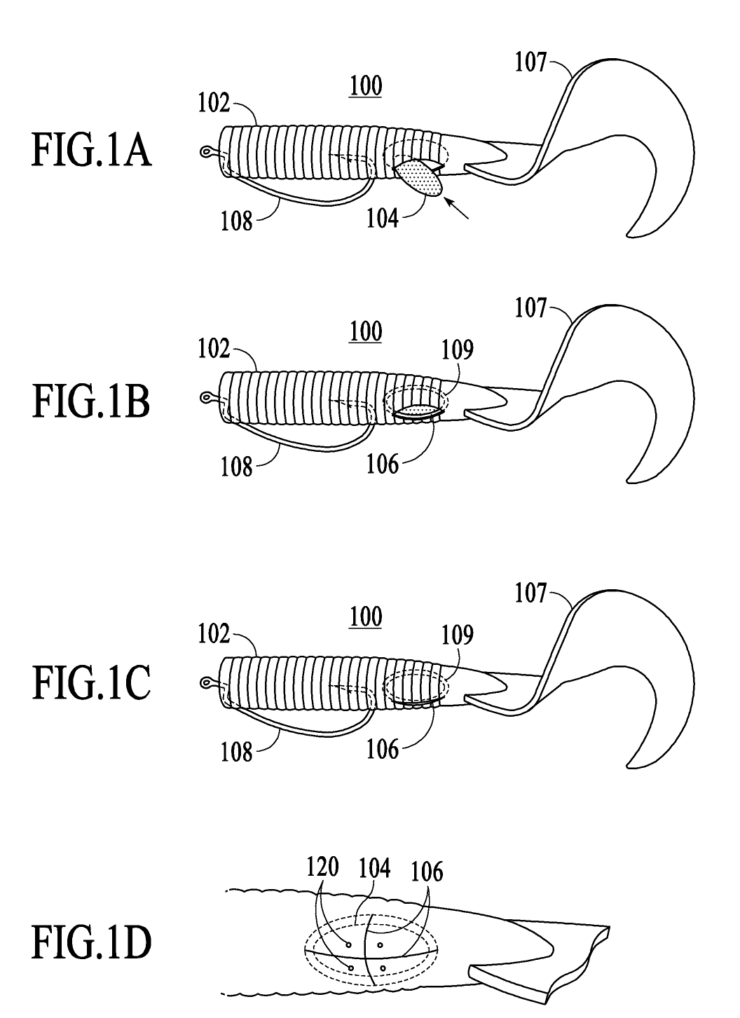

FIGS. 1A, 1B and 1C are representative side view of multi-functional fishing lure of the present invention 100. As shown in FIG. 1A, multi-functional fishing lure 100 consists of body portion 102 integrally connected to tail portion 107 and detachably to hook 108. In one embodiment, body portion 102 and tail portion 107 are made from flexible non-toxic materials such as plastic, resin, polymer, etc. Multi-functional fishing lure 100 can be manufactured in any color and any shape such as worm-shape, insect-shaped, fish-shaped as long as when the present invention 100 is immersed in water, it generates movements that mimic natural preys such as worms and fish. In one embodiment, body portion 102 is attached to hook 108 mechanically and detachably.

As best shown in FIGS. 1A, 1B and 1C, there is attractant tablet chamber 109 situated within body portion 102. In one embodiment, attractant tablet chamber 109 is a cavity with the capacity to retain attractant tablet 104 in place. As shown in FIG. 1B, the opening of attractant tablet chamber 109 is flexibly closed by chamber lid 122 with slit opening 106. FIG. 1D is a representative expanded view showing details of chamber lid 122. Slit opening 106 optionally can be a horizontal slit or cross slits, as best shown in FIG. 1D, that keeps attractant tablet 104 from falling out of attractant tablet chamber 109 but still allowing water flowing in and out of attractant tablet chamber 109. In one embodiment, while multi-functional fishing lure 100 is immersed in water, as the prevent invention 100 is moving, water will flow in, dissolve portion of attractant tablet 104 and carry the ingredients out of attractant tablet chamber 109. As best shown in FIG. 1D, small apertures 120 can be created on chamber lid 122 to control rate of dispersion of fish attracting scent 304, cloud of blood red color 306, and/or bubbles 300 out of attractant tablet chamber 109.

It will be understood that pill or tablet 104 can be placed inside chamber portion 109 through covering slot portions 106 and replaced when totally dissolved. Upon dissolving, the scent, colorant and bubbles will be released optionally through small openings or releasing apertures 120.

In one embodiment, attractant tablet 104 is a pill in any shape that contains non-toxic and environmentally safe active ingredients that are dissolvable in either fresh and salt/sea water environment in a time release manner. In one embodiment, attractant tablet 104 can be made of solid ingredients and pressed into a tablet form. Alternatively, attractant tablet 104 can be made of absorbent materials such as sponge that absorbs active ingredients in liquid form, or combination thereof. In one embodiment, ingredients of attractant tablets perform one of the following functions and combinations thereof:

Scent: when attractant tablet 104 is in contact with aqueous environment such as fresh water or sea water, one of its active ingredients will slowly dissolve and time releases a fish scent attractant 304 as best shown in FIG. 3. The fish scent attractant of attractant tablet 104 create a constant cloud of fish attracting scent 304 surrounding the multi-functional fishing lure 100 to effectively draw predators to swallow multi-functional fishing lure 100 and get hooked as a result. In one embodiment, the active ingredients can be various compounds found in natural fish that attract and/or have a positive physiological effect on predatory fish. Such ingredients include, but not limited to, amino acids, appropriate proteins, citrates, ionic compounds.

In the case that attractant tablet 104 is in a cellular sponge format, it can be saturated with a polyvinyl alcohol solution which contains a fish attractant such as fish meal, blood meal, etc., and a water soluble borate gelling agent, e.g., sodium borate, at a concentration of about 0.01 to 1 weight percent in the polyvinyl alcohol solution. The fish attractant is present in an effective amount, typically from about 2 to about 25 weight percent in the polyvinyl alcohol. The polyvinyl alcohol solution gels within the sponge and the sponge thus reduces or retards the rate of dissolution of the polyvinyl alcohol when the lure is placed in water. This prolongs the useful life of the lure, permitting it to be used repeatedly, before requiring replacement with a fresh sponge lure. Alternatively, attractant tablet 104 can simply be impregnated with commercially available fish scent spray such as Trigger X Fish Scent Spray or Atlas Mikes Gel Scent. Users can select individual commercially available fish scent spray/solution and combination thereof for their specific fishing needs.

Color: when attractant tablet 104 is in contact with aqueous environment such as fresh water or sea water, one of its active ingredients will slowly dissolve and time releases a cloud of blood red color 306 as best shown in FIG. 3. It is well-known that predatory fish attacks are triggered by visual stimulation. Blood red cloud 306 surrounding the present invention 100 provides such stimulation and will effectively lure predatory fish to attack under the illusion that its prey is in its most vulnerable state.

In one embodiment, the active ingredients can simply be commercially available red dye, which is non-toxic, environmentally safe and allowable to be used for fishing, in solid form and pressed into attractant tablet 104. In the case that attractant tablet 104 is in a sponge format, the liquid dye can simply to be impregnated into attractant tablet 104. In one embodiment, users can also easily tell whether attractant tablet 104 is still effective by simply observing the color of attractant tablet 104. If it turns pink or pale, users will know it is time to replace attractant tablet 104.

Bubbles: when attractant tablet 104 is in contact with aqueous environment such as fresh water or sea water, one of its active ingredients will react with water chemically and create a constant stream of tiny bubbles 300 as best shown in FIG. 3. Users can also tell when to replace attractant tablet 104 when bubbles cease to come up.

In one embodiment, the generation of bubbles can be achieved by effervescence which is the escape of gas from an aqueous solution. The term is used to describe the foaming or fizzing that results from a release of gas. A common example of effervescence is the addition of hydrochloric acid to a block of limestone. If a few pieces of marble or an antacid tablet are put in hydrochloric acid in a test tube fitted with a cork, effervescence of carbon dioxide can be witnessed.

CaCO₃+2HCl→H₂CO₃+CaCl₂

The carbonic acid formed rapidly decomposes into water and carbon dioxide gas, thus the reaction becomes:

CaCO₃+2HCl→H₂O+CO₂ (bubbles)+CaCl₂

Another chemical reaction that produces gas is the reaction of sodium bicarbonate with acid, for example in Alka-Seltzer™ brand tablets, used to treat stomach indigestion. The essential chemical reaction is:

Citric Acid+Sodium Bicarbonate→Water+Carbon Dioxide+Sodium Citrate

C₆H₈O₇+3 NaHCO₃→3 H2O+3 CO₂ (bubbles)+NaC₆H₅O₇

The process of carbon dioxide bubbling out of solution is generally represented by the following reaction, where a pressurized dilute solution of carbonic acid in water releases a gaseous carbon dioxide at decompression:

H₂CO₃→H₂O+CO₂ (bubbles)

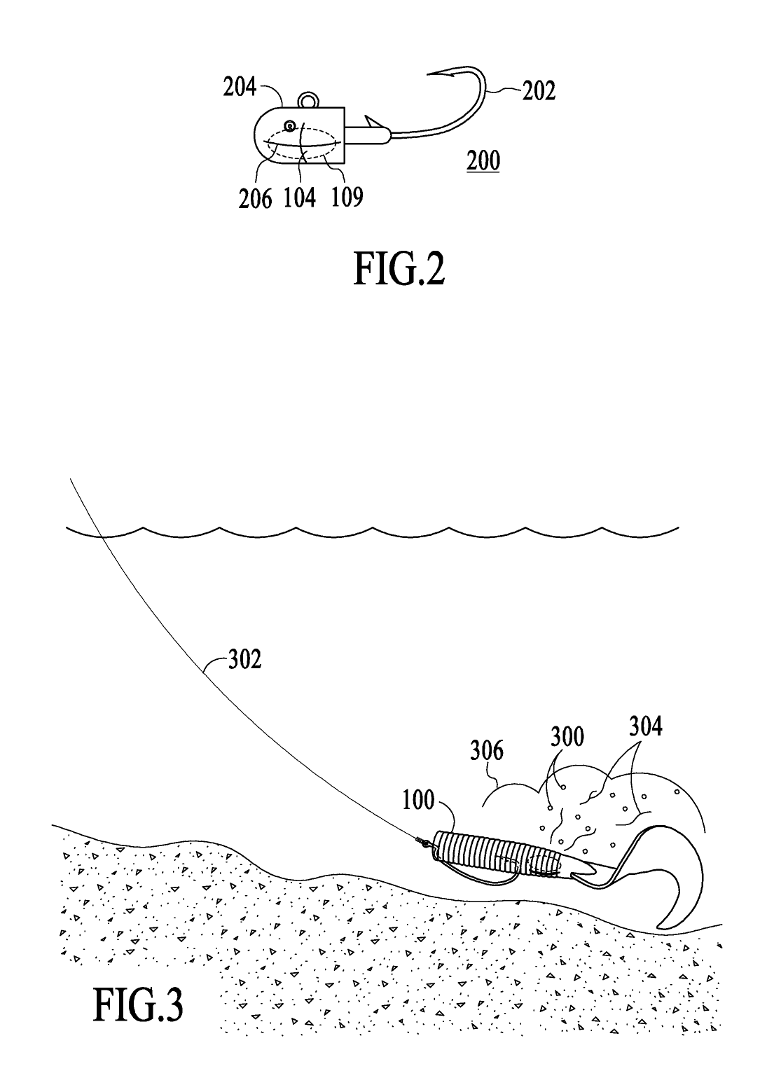

FIG. 2 is a representative side view of an alternative embodiment of multi-functional fishing lure of the present invention 100′. As best shown in FIG. 2, multi-functional fishing lure of the present invention 100′ consists of only hook holder portion 204 integrally attached to hook 202. In one embodiment, attractant tablet chamber 109 is located within hook holder 204 with slit opening 206. As best shown in FIG. 2, attractant tablet 104 is disposed, when required, through slit opening 206 and secured within attractant tablet chamber 109.

FIG. 3 is a representative view of application of multi-functional fishing lure of the present invention 100. As best shown in FIG. 3, users inserted attractant tablet 104 through slit opening 106 of multi-functional fishing lure 100. When the present invention 100 is immersed in water, water will flow in from slit opening 106 into attractant tablet chamber 109 and get in contact with attractant tablet 104. Chemical reactions are carried out among water and active ingredients of attractant tablet 104. Consequently, fish scent attractant 304, cloud of blood red color 306, and/or bubbles 300 will be generated and dispersed into surrounding water through slit opening 106. In one embodiment, fish scent attractant 304, cloud of blood red color 306, and/or bubbles 300 will be released continually, when in combination of the natural movement of the present invention, creating a predatory fish attracting environment surrounding with both scent and visual stimulants throughout the entire time the present invention 100 is immersed in water.

It is believed that with the scent and visual stimulants generated wherefrom multi-functional fishing lure of the present invention 100, it is more likely that predatory fish will be prone to attack and get hooked as a result. In one embodiment, in the case that attractant tablet 104 is in a pill form, users will know the appropriate time to replace attractant tablet 104 when it is completely or nearly dissolved. In the case that attractant tablet 104 is in a sponge form, users can observe the fading red color of attractant tablet 104. Alternatively, users can simply observe bubbles 300 and/or cloud of blood red color 306 surrounding the present invention 100 during fishing and determine a replacement when the visual stimulants appear to be weakening.

### Example Compositions

This invention is a water-soluble optionally polymeric-based capsule or pill 104 providing visual, olfactory and predatory stimulation of fish. The pill 104 or capsule which is inserted into the slotted opening in the flexible body of the worm releases scent, color and bubbles. U.S. Pat. No. 4,927,643 issued May 22, 1990 to D'Orazio et al. teaches a soluble fish-attractant coating, coated lure, and coating composition and method.

More specifically, this invention has a water-soluble, optionally polymeric material with an odoriferous fish-attractant material dispersed in it. The material dissipates when the fishing lure 100 is in the water, steadily releasing the fish-attractant, color and bubbles into the water at the site of the lure 100 to attract fish to it.

The composition optionally includes a volatile solvent, active ingredients dissolved in the solvent and capable of forming a water-soluble coating or other hardened tablet or pill 104 form, including a fish-attractant material dispersed in the material. The composition preferably includes a neutralizer in an amount sufficient to render the polymeric material water-soluble to a predetermined extent. If the polymeric material is acidic, as preferred, the neutralizer will be a base. On the other hand, if the polymeric material is alkaline, the neutralizer will be acidic.

The odoriferous fish-attractant materials used in a liquid or solid composition may vary greatly, both in constituents and in amounts thereof. It is highly preferred to utilize a mixture of odoriferous fish-attractant materials. Such olfactory stimulants may be: fish oils; extracts of various fishes and fish by-products; extracts and residues of earthworms, grubs and insects; anise oil; certain essential oils; certain amino acids, such as L-proline and L-leucine; fish egg extract; fish meal homogenate; morpholine; and various mixtures of these materials. Particularly preferred materials which may be blended together for use are anise oil, fish oil and amino acids.

The fish-attractant materials may be liquids, as in the case of the aforementioned oils, or they may include very small solid particles, preferably of minuscule size. The size of such particles can be minimized by blending, or other processing steps. When in liquid or solid form, the fish-attractant materials may be thoroughly dispersed in the liquid composition and, ultimately, substantially homogeneously dispersed in the water-soluble tablet, pill 104 or coating formed from such liquid composition. The amounts and proportions of the constituents of the liquid composition of this invention can vary greatly.

The precise solubility characteristics of the fish-attractant coating of this invention can readily be predetermined. Pills or capsules 104 requiring on the order of one day of exposure during fishing (e.g., about four hours in the water) may readily be made. Likewise, pills or capsules 104 having an intentionally shorter life (e.g., two hours or less) may readily be made.

In some cases, it is considered desirable to make the useful life of a pill 104 sufficiently short such that the pill 104 in the chamber 109 of the lure 100 may be frequently replaced. Some fishermen may even wish to change pills 104 from time to time as a part of their tactical moves in fishing for certain species of fish.

The fist-attractant scent material is preferably present in an amount of about 0.01% to about 99% by weight of the pill 104. More preferably, the fish-attractant scent material is present in an amount of about 50% to about 90% by weight of the pill 104. About 80% is highly preferred.

The color-releasing material is preferably present in an amount of about 0.01% to about 50% by weight of the pill 104. More preferably, the color-releasing material is present in an amount of about 1% to about 20% by weight of the pill 104. About 10% is highly preferred.

The bubble-releasing material is preferably present in an amount of about 0.01% to about 50% by weight of the pill 104. More preferably, the bubble-releasing material is present in an amount of about 1% to about 20% by weight of the pill 104. About 10% is highly preferred.

It is believed that fish have very sensitive olfactory systems. For example, some experts believe that the olfactory system of a dog may be about one thousand times more sensitive than that of a human being, and that the olfactory systems of fish may be on the order of one thousand times more sensitive than that of a dog. For this reason, it is believed that too much fish-attractant material might in some cases repel fish, or perhaps be unnecessary.

In summary, a composition of the pill 104 follows:

| | | |
|---|---|---|
| Fist-attractant Scent Material | 0.01%-99% | (by weight) |
| Color-Releasing Material | 0.01%-50% | |
| Bubble-Releasing Material | 0.01%-50% | |

Another composition of the pill 104 follows:

| | | |
|---|---|---|
| Fist-attractant Scent Material | 50%-90% | (by weight) |
| Color-Releasing Material | 1%-20% | |
| Bubble-Releasing Material | 1%-20% | |

Yet another composition of the pill 104 follows:

| | | |
|---|---|---|
| Fist-attractant Scent Material | 80% | (by weight) |
| Color-Releasing Material | 10% | |
| Bubble-Releasing Material | 10% | |

It will be understood that the rates of dissolving of the pill 104 or the individual different components scent, colorant and bubble-releasing material bay be varied based upon formulation. Pills 104 of different composition may be used alternatingly, or as desired, depending upon water conditions, weather conditions, time of day, type of fish sought, etc.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A multi-functional fishing lure assembly to generate visual simulation and scent, the multi-functional fish lure comprising:
a soft, flexible and elongated body portion having two ends, one end detachably coupled with a fishing hook, the opposite end attached integrally to an elongated tail portion;
a chamber having an opening disposed in the elongated body portion, the chamber further having an opening for access to the chamber, the opening comprising slits in the body portion of the lure;
a volume of active ingredients, the volume of active ingredients further comprising scent material, color material, bubbles generating material and combinations thereof, the volume of active ingredients disposed securely inside the chamber, wherein the volume of active ingredients can be reloaded and reused.

2. The multi-functional fishing lure of claim 1 in which the body portion is manufactured of materials selected from the group consisting of silicon rubber, plastic, resin and leather.

3. The multi-functional fishing lure of claim 1 in which the tail portion is manufactured of materials selected from the group consisting of silicon rubber, plastic, resin and leather.

4. The multi-functional fishing lure of claim 1 in which the volume of active ingredients is a solid tablet.

5. The multi-functional fishing lure of claim 4 in which the solid tablet is manufactured by pressing and molding active ingredients in a solid form.

6. The multi-functional fishing lure of claim 1 in which the volume of active ingredients is in a sponge form.

7. The multi-functional fishing lure of claim 6 in which the volume of active ingredients impregnated with scent material, color material, bubble generating material, and combination thereof in liquid form.

8. The multi-functional fishing lure of claim 1 in which the scent material is manufactured of materials selected from the group consisting of fish meal, blood meal, amino acids, appropriate proteins, citrates and ionic compounds.

9. The multi-functional fishing lure of claim 1 in which the color material is a red dye resembling blood color.

10. The multi-functional fishing lure of claim 1 in which the bubbling generating material is manufactured of effervescence materials.

11. The multi-functional fishing lure of claim 7 in which the scent material is fish scent spray.

12. The multi-functional fishing lure of claim 1 in which the volume of active ingredients is comprised of:
a fish-attractant scent material in an amount of about 0.01% to about 99% by weight;
a color-releasing material in an amount of about 0.01% to about 50% by weight; and
a bubble-releasing material in an amount of about 0.01% to about 50% by weight.

13. The multi-functional fishing lure of claim 12 in which the volume of active ingredients is comprised of:
a fish-attractant scent material in an amount of about 50% to about 90% by weight;
a color-releasing material in an amount of about 1% to about 20% by weight; and
a bubble-releasing material in an amount of about 1% to about 20% by weight.

14. The multi-functional fishing lure of claim 12 in which the volume of active ingredients is comprised of:
a fish-attractant scent material in an amount of about 80% by weight;
a color-releasing material in an amount of about 10% by weight; and
a bubble-releasing material in an amount of about 10% by weight.

15. A method of fishing, the method of fishing comprising:
Obtaining a multi-functional fishing lure comprising a soft, flexible and elongated body portion having two ends, one end detachably coupled with a fishing hook, the opposite end attached integrally to an elongated tail portion; a chamber having an opening disposed in the elongated body portion, the chamber further having a lid portion, the lid portion further having slits and apertures; a volume of active ingredients, the volume of active ingredients further comprising scent material, color material, bubbles generating material and combination thereof;
Disposing the volume of active ingredients inside the chamber;
Immersing the multi-functional fishing lure in water;
Observing bubbles and red color cloud dispersing from the multi-functional fishing lure, replacing the volume of active ingredients when bubbles ceased to rise or red color cloud faded; and
Replacing the volume of active ingredients when it is completely dissolved.
